(19) United States
(12) Patent Application Publication
(10) Pub. No.: US 2012/0002918 A1
(43) Pub. Date: Jan. 5, 2012

(54) WAVELENGTH MULTIPLEXER/DEMULTIPLEXER AND METHOD OF MANUFACTURING THE SAME

(75) Inventors: Hiroshi KAWASHIMA, Tokyo (JP); Kazutaka NARA, Tokyo (JP); Junichi HASEGAWA, Tokyo (JP)

(73) Assignee: FURUKAWA ELECTRIC CO., LTD., Tokyo (JP)

(21) Appl. No.: 13/167,097

(22) Filed: Jun. 23, 2011

(30) Foreign Application Priority Data
Jul. 2, 2010 (JP) 2010-151728

(51) Int. Cl. G02B 6/28; G02B 6/10

(52) U.S. Cl. 385/24; 264/1.24

(57) ABSTRACT

The present invention provides a wavelength multiplexer/demultiplexer comprising a Mach-Zehnder interferometer and an arrayed waveguide diffraction grating, the wavelength multiplexer/demultiplexer having a simple configuration and being capable of reducing the degradation in the temperature compensation characteristics of a temperature compensation material provided in the Mach-Zehnder interferometer or the peeling-off of the temperature compensation material, and a method of manufacturing the same. A wavelength multiplexer/demultiplexer comprises an AWG including two separated slab waveguides and an MZI including two arm waveguides. A temperature compensation groove is formed in the two arm waveguides, wherein in a space between the temperature compensation groove, and two separated slab waveguides, a compensation material, the refractive index matching that of the AWG or Mach-Zehnder interferometer, the compensation material having a temperature dependence coefficient with a sign different from that of the temperature dependence coefficient of the waveguide core and having plasticity or fluidity, is filled.

### BACKGROUND OF THE INVENTION

1. Field of the Invention

The present invention relates to a wavelength multiplexer/demultiplexer and a method of manufacturing the same, and more specifically relates to a wavelength multiplexer/demultiplexer achieving athermalization and a method of manufacturing the same.

2. Description of the Related Art

As a method for suppressing the temperature dependence of a transmission wavelength of an arrayed waveguide diffraction grating (AWG) and achieving athermalization, two methods have been mainly proposed and put into practical use.

The first method for achieving athermalization is a method, wherein a groove crossing an optical path is provided in an arrayed waveguide or a slab waveguide of the AWG, and wherein a temperature compensation material (usually, a silicone resin) having a negative temperature dependence of refractive index and having an absolute value thereof several tens of times as large as that of the temperature dependence coefficient of refractive index of a material (usually, a silica-based glass) constituting the waveguide is filled into the groove to thereby cancel the temperature dependence of refractive index of the waveguide itself (see Japanese Patent No. 3436937).

The second method for achieving athermalization is a method, wherein in an AWG chip, a part of an input (output) waveguide of the AWG is separated from the remaining part, or the input (output) waveguide and a part on the input (output) waveguide side of a slab waveguide are separated from the remaining part, and wherein the both parts are connected to each other by using a compensation member having a thermal expansion coefficient larger than that of the chip, so that the relative position between the both is changed in accordance with the change in temperature to cause the input (output) waveguide to follow a variation of the focus position at the slab waveguide end with the change in temperature (see Japanese Patent No. 3434489). A technique for suppressing the reflection or radiation loss by filling a refractive-index matching material into the space between the separated chips is disclosed in Japanese Patent Laid-Open No. 2001-188141. Moreover, in the technique disclosed in Japanese Patent Laid-Open No. 2001-188141, for the purpose of securing reliability such as the protection from the humidity of waveguide glass, a module is used in which the entire chip is immersed into the refractive-index matching material and which is hermetically sealed.

On the other hand, as a method for expanding the transmission wavelength bandwidth of the arrayed waveguide diffraction grating (AWG), an MZI-AWG is proposed in which a Mach-Zehnder interferometer (MZI) is provided in an input waveguide of the arrayed waveguide to synchronize the frequency characteristics of AWG and MZI with each other (see Japanese Patent No. 3256418).

As a method for athermalizing the transmission wavelength of this MZI-AWG, two methods have been mainly proposed by applying the above-described AWG athermalization approach (see Japanese Patent Laid-Open No. 2009-186688 and Japanese Patent Laid-Open No. 2009-180837).

The first method for achieving the athermalization of the MZI-AWG is a method, wherein a groove crossing an optical path is provided in an arm waveguide of the MZI and in an arrayed waveguide or a slab waveguide of the AWG, and wherein a temperature compensation material having a negative temperature dependence of refractive index and having an absolute value thereof several tens of times as large as that of the temperature dependence coefficient of a material constituting the waveguide is filled into the groove.

The second method for achieving the athermalization of MZI-AWG is a method, wherein into a groove which is formed in an arm waveguide of the MZI so as to cross the arm waveguide, a temperature compensation material having a negative temperature dependence of refractive index and having an absolute value thereof several tens of times as large as that of the temperature dependence coefficient of a material constituting the waveguide is filled, and wherein in an AWG chip, a part of an input (output) waveguide of the AWG is separated from the remaining part, or the input (output) waveguide and a part on the input (output) waveguide side of a slab waveguide are separated from the remaining part, and wherein the both parts are connected to each other by using a compensation member having a thermal expansion coefficient larger than that of the chip, so that the relative position between the both is changed in accordance with the change in temperature to cause the input (output) waveguide to follow a variation of the focus position at the slab waveguide end with the change in temperature.

Among these, in the second method for achieving the athermalization of the MZI-AWG, from the viewpoint of securing reliability as described above, the entire chip comprising the MZI-AWG is preferably immersed into a refractive-index matching material. However, in this case, the refractive-index matching material may contact the temperature compensation material filled into the MZI section, and thus the mixing of the refractive-index matching material or an impurity contained therein into the temperature compensation material, the degradation in the temperature compensation characteristics of the temperature compensation material because of the mutual chemical reaction, or the peeling-off of the temperature compensation material from the groove wall surface might occur, thereby having posed a problem.

Moreover, even in cases where the entire chip comprising the MZI-AWG is not immersed into a refractive-index matching material, it is preferable, from the viewpoint of suppressing the reflection or radiation loss, to fill a refractive-index matching material into the separation part in the slab waveguide. In this case, in order to prevent the temperature compensation material provided in the MZI and the refractive-index matching material filled into the above-described separation part from contacting each other, a temperature compensation material filled part needs to be spaced apart from the refractive-index matching material filled part, thereby having caused a problem of increasing the size.

In order to solve these problems, there have been also proposed a method of covering the surface of a temperature compensation material provided in the MZI with a protection film (see Japanese Patent Laid-Open No. 2009-180837) and a method of forming a groove or the like used for suppression of the flowing-out of the temperature compensation material (see Japanese Patent Laid-Open No. 2006-330280). However, these methods have caused a problem of a cost increase because of an increase in the number of members or of steps. Furthermore, the above-described protection film, groove for suppressing the flowing-out, or the like needs to be provided in the chip comprising the MZI-AWG, thereby having introduced complexity of the device.

### SUMMARY OF THE INVENTION

An object of the present invention is to provide a wavelength multiplexer/demultiplexer comprising a Mach-Zehnder interferometer and an arrayed waveguide diffraction grating, the wavelength multiplexer/demultiplexer having a simple configuration and being capable of reducing the degradation in the temperature compensation characteristics of a temperature compensation material provided in the Mach-Zehnder interferometer and reducing the peeling-off of the temperature compensation material, and a method of manufacturing the same.

A first aspect of the present invention is a wavelength multiplexer/demultiplexer, comprising: a Mach-Zehnder interferometer having two arm waveguides coupled to one or more first waveguides; and an arrayed waveguide diffraction grating including a first slab waveguide coupled to the Mach-Zehnder interferometer, an arrayed waveguide having a plurality of waveguides of different optical path lengths coupled to the first slab waveguide, a second slab waveguide coupled to the arrayed waveguide, and a plurality of second waveguides arranged in parallel and coupled to the second slab waveguide, wherein the first slab waveguide is separated in a plane crossing a path of light passing through the first slab waveguide, the wavelength multiplexer/demultiplexer further comprising: a first member having one of the separated first slab waveguides and the Mach-Zehnder interferometer provided therein; a second member having the other one of the separated first slab waveguides and the arrayed waveguide provided therein; and a temperature compensation mechanism which changes a relative position between one of the separated first slab waveguides and the other one of the separated first slab waveguides by moving at least one of the first member and the second member in accordance with the change in temperature so that a temperature dependence of a transmission center wavelength of the arrayed waveguide diffraction grating decreases, wherein a groove provided so as to cross the arm waveguide is formed in at least one of the two arm waveguides of the Mach-Zehnder interferometer, and into the groove, and between one of and the other one of the separated first slab waveguides, an identical compensation material having a refractive index matching that of a waveguide core of the arrayed waveguide diffraction grating and the Mach-Zehnder interferometer, a temperature dependence coefficient different from a temperature dependence coefficient of the waveguide core, and plasticity or fluidity, is filled.

A second aspect of the present invention is a method for manufacturing the wavelength multiplexer/demultiplexer according to claim 1, the method comprising the steps of: preparing a configuration having the arrayed waveguide diffraction grating, the Mach-Zehnder interferometer, and the temperature compensation mechanism formed therein; and filling the identical compensation material into the groove, and between one of and the other one of the separated first slab waveguides.

### BRIEF DESCRIPTION OF THE DRAWINGS

FIG. 1 is a top view of a wavelength multiplexer/demultiplexer according to an embodiment of the present invention.

FIG. 2 is a cross-sectional view when viewed along A-A′ line of FIG. 1.

FIG. 3 is a graph showing the temperature dependence of a transmission center wavelength for each of the wavelength multiplexer/demultiplexer according to an embodiment of the present invention and a wavelength multiplexer/demultiplexer without temperature compensation.

FIG. 4 is a graph showing a temporal change of a transmission center wavelength variation for each of the wavelength multiplexer/demultiplexer according to an embodiment of the present invention and a wavelength multiplexer/demultiplexer according to a related art example.

FIG. 5 is a view showing the steps of manufacturing the wavelength multiplexer/demultiplexer according to an embodiment of the present invention.

FIG. 6 is a view showing the steps of manufacturing a wavelength multiplexer/demultiplexer according to an embodiment of the present invention.

### DETAILED DESCRIPTION OF THE INVENTION

Hereinafter, embodiments of the present invention will be explained in detail with reference to the drawings. Meanwhile, in drawings explained below, those having the same function are given the same reference numeral, and the repeated explanation thereof is omitted.

### First Embodiment

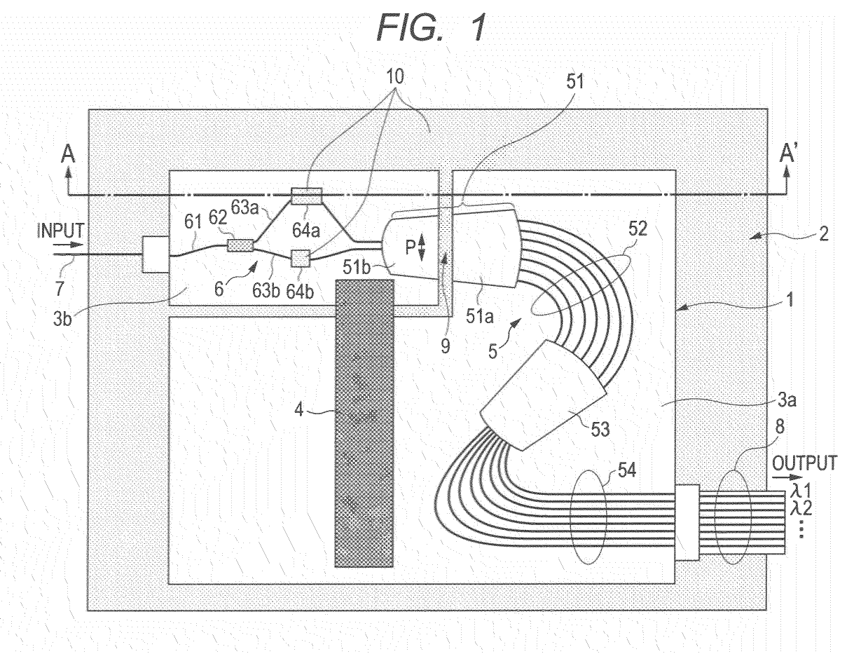

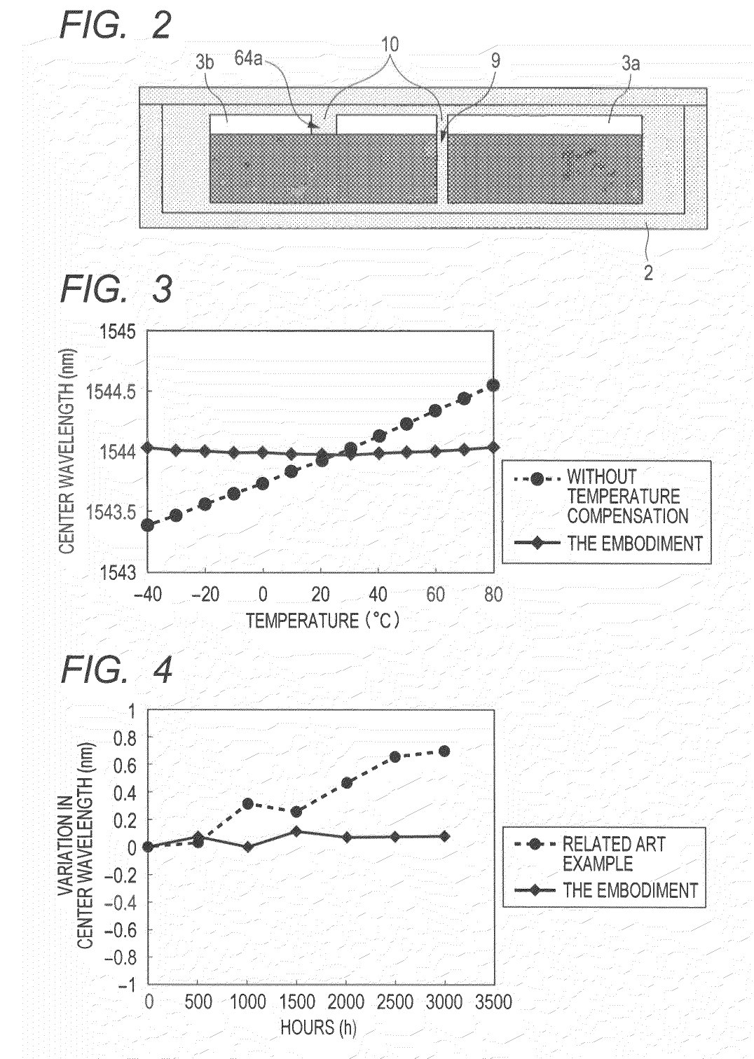

FIG. 1 is a top view of a wavelength multiplexer/demultiplexer according to a first embodiment, and FIG. 2 is a cross-sectional view when viewed along A-A′ line of FIG. 1.

In FIG. 1, inside a package 2, a wavelength multiplexer/demultiplexer 1 (hereinafter, may be simply referred to as a “chip”) is provided. The wavelength multiplexer/demultiplexer 1 comprises a first substrate section 3a and a second substrate section 3b, wherein the first substrate section 3a and the second substrate section 3b are connected to each other via a compensation member 4. The first substrate section 3a and the second substrate section 3b may be formed separately or may be separated from a single substrate to be formed.

An arrayed waveguide diffraction grating (AWG) is formed on the first substrate section 3a and the second substrate section 3b. An AWG5 comprises a slab waveguide 51, an arrayed waveguide 52 including a plurality of different waveguides each having a different optical path length, a slab waveguide 53, and an output waveguide 54 including a plurality of waveguides. In the embodiment, the slab waveguide 51 is separated into two parts in a plane crossing a path of light passing through the slab waveguide 51, wherein a separated slab waveguide 51a which is one part of the separated slab waveguide 51 is provided on the first substrate section 3a and a separated slab waveguide 51b which is the other part is provided on the second substrate section 3b. It should be noted that a space 9 is formed in the separation part formed between the separated slab waveguide 51a and the separated slab waveguide 51b.

On the second substrate section 3b, in addition to the separated slab waveguide 51b, a Mach-Zehnder interferometer (MZI) 6 is provided. The MZI6 comprises an input waveguide 61, an optical splitter 62, and arm waveguides 63a and 63b. The arm waveguides 63a and 63b are arranged adjacent to each other so that the lights transmitting through the respective waveguides interfere with each other in the output section of the MZI6, wherein the adjacent arm waveguides 63a and 63b are optically coupled to the separated slab waveguide 51b. Therefore, the MZI6, the separated slab waveguide 51b, and the separated slab waveguide 51a are arranged so that the light transmitting through the MZI6 enters the separated slab waveguide 51b and further enters the separated slab waveguide 51a.

It should be noted that, in the embodiment, an example is shown in which one input waveguide 61 is provide, but two or more input waveguides 61 may be arranged in parallel.

In each of the arm waveguides 63a and 63b, temperature compensation grooves 64a and 64b for filling therein a material (a compensation material to be described later) serving as the temperature compensation material for athermalization of the MZI6 are formed. It should be noted that, in the embodiment, the temperature compensation grooves 64a and 64b are provided in both of the arm waveguides 63a and 63b, but the temperature compensation groove may be provided in either one of the arm waveguides 63a and 63b.

Moreover, an input optical fiber 7 is optically coupled to the input waveguide 61 of the MZI6, while a plurality of output optical fibers 8 is optically coupled to the output waveguide 54 of the AWG5.

The compensation member 4 is a member which, when the temperature of the use environment of the AWG5 varies by a predetermined temperature, expands/contracts because of thermal expansion so that the second substrate section 3b moves by a predetermined amount. The compensation member 4 comprises aluminum, for example. That is, the compensation member 4 functions as a mechanism for moving the separated slab waveguide 51b (that is, the second substrate section 51b) in the direction to reduce the temperature-dependent variation of each transmission center wavelength of the AWG5, in other word, the compensation member 4 functions as a mechanism for reducing the temperature dependence of the transmission wavelength of the AWG5 by changing the relative position between the separated slab waveguide 51a and the separated slab waveguide 51b in accordance with the change in temperature.

In FIG. 1, the wavelength multiplexer/demultiplexer 1 is arranged inside the package 2 via a elastic member (not shown) having a cushioning property so as not to prevent the change in the relative position between the first substrate section 3a and the second substrate section 3b because of the thermally expanding/contracting compensation member 4. Accordingly, the second substrate section 3b connected to the first substrate section 3a via the compensation member which thermally expands/contracts by the change in temperature will relatively move, in an arrow direction P of FIG. 1 relative to the first substrate section 3a, in accordance with the change in the temperature of use environment. The separated slab waveguide 51b will also move in the arrow direction P in accordance with the change in temperature. Accordingly, even if the temperature of use environment varies, the compensation member 4 deforms in accordance with the temperature variation, and thus the separated slab waveguide 51b can be relatively moved so as to correct the incident position of light onto the separated slab waveguide 51a, and the temperature variation at the position of the output waveguide 54, on which the light should be focused for each wavelength, can be reduced.

It should be noted that, in FIG. 1, the wavelength multiplexer/demultiplexer 1 functions as a demultiplexer by receiving the input light from the optical fiber 7 and outputting the output light from the optical fiber 8, and also functions as a multiplexer by receiving the input light from the optical fiber 8 and outputting the output light from the optical fiber 7.

In the embodiment, as shown in FIG. 1 and FIG. 2, the entire chip including the space 9 and the temperature compensation grooves 64a and 64b is covered with an identical compensation material 10.

From the viewpoint of the matching of refractive indexes, the compensation material 10 has substantially the same refractive index as that of the waveguide core (e.g., a silica-based glass) of the AWG5 and MZI6 at near the use temperature, and also from the viewpoint of athermalization of the MZI6, a temperature dependence coefficient dn₂/dT of the refractive index has a sign opposite to that of a temperature dependence coefficient dn₁/dT of the refractive index of the waveguide core, wherein the absolute value of the former is approximately 30 to 40 times as large as that of the latter. Where n₁ is the refractive index of the above-described waveguide core and n₂ is the refractive index of the compensation material.

Thus, in the space 9 as the cut part of the slab, the compensation material serves, as a refractive-index matching material, to reduce the reflection and/or radiation loss of propagated light, while in the temperature compensation grooves 64a and 64b, the compensation material, as the refractive-index matching material, reduces the radiation loss of propagated light. and also varies the refractive-index thereof in a direction opposite to that of the waveguide core in accordance with the ambient temperature. Therefore, the compensation material serves to suppress the temperature variation of the refractive index as the entire arm waveguides 63a and 63b of the MZI6 and reduce the temperature dependence of the transmission wavelength of the MZI6.

Moreover, the compensation material 10 preferably has an adequate hardness of such a degree that does not prevent the temperature compensation operation (the movement of the separated slab waveguide 51b (the second substrate section 3b) corresponding to the temperature variation) of the AWG5 performed by the compensation member 4, and specifically, the compensation material is preferably in the form of a liquid having a viscosity of 10000 mm²/s or less. Moreover, a resin which, when interposed in the space 9, deforms to the extent that does not prevent the above-described temperature compensation operation of the AWG5 performed by the compensation member 4, may be used as the compensation material of the present invention.

Furthermore, for the purpose of securing the reliability under high temperature and high humidity environment, the compensation material is preferably water-insoluble.

For example, when a silica-based glass is used as the waveguide core of the AWG5 and MZI6, a silicone oil or silicone gel, for example, can be used as such a compensation material, and specifically, the product name OF-38E produced by Shin-Etsu Chemical Co., Ltd., the product name OP-101 or the like produced by Dow Corning Toray Co., Ltd., the product name X38-7427 produced by Shin-Etsu Chemical Co., Ltd. and the product name X38-452 or the like produced by Shin-Etsu Chemical Co., Ltd. can be used.

As described above, what is important in this embodiment is that in the wavelength multiplexer/demultiplexer formed by combining the AWG5 with the MZI6, the refractive-index matching material for matching the refractive indexes of the slab waveguides 51a and 51b, which are the separated AWG5, and the temperature compensation material for athermalization of the MZI6 are the identical compensation material, and that the relative position change between the separated slab waveguides 51a and 51b of such a degree that eliminates the temperature-dependent variation of each transmission center wavelength is not prevented. Accordingly, in the embodiment, as the compensation material, any compensation material, the refractive index of which matches that of the waveguide core of the AWG and MZI and which has a temperature dependence coefficient different from the temperature dependence coefficient of the waveguide core and has plasticity or fluidity, may be used. Moreover, if a material having a temperature dependence coefficient with a sign different from that of the temperature dependence coefficient of the waveguide core is used as the compensation material, the temperature compensation can be carried out more efficiently.

By filling such a compensation material into the space 9 and the temperature compensation grooves 64a and 64b, the temperature compensation material and the refractive-index matching material can be the identical compensation material. It is therefore possible to reduce factors such as the degradation in the temperature compensation characteristics because of the mixing or mutual chemical reaction of the temperature compensation material and the refractive-index matching material and/or the degradation of reliability including the peeling-off of the temperature compensation material because of the refractive-index matching material entering the interface between the temperature compensation material and the groove formed in the chip. In addition, since the groove and the cut part of the chip (space 9) can be arranged adjacent to each other, the size can be reduced. Moreover, by reducing the members to be used, the material cost can be reduced. Furthermore, since there is no need to cover the temperature compensation groove, which has been filled with the temperature compensation material, with a protection film or to provide a groove for suppressing the flowing-out of the temperature compensation material, the configuration of the device can be simplified.

In the following, in consideration of the conditions of the compensation material of the above-described embodiment, in the case where a silicone oil having dn₂/dT-40×10⁻⁵ (1/° C.) (while a silica glass has dn₁/dT=approximately 1×10⁻⁵ (1/° C.)) and having a viscosity of approximately 1000 mm²/s is filled as the compensation material into the space 9 and the temperature compensation groove 64a, the center wavelength dependence on the temperature variation of the wavelength multiplexer/demultiplexer was measured and the reliability test of the wavelength multiplexer/demultiplexer was conducted. It should be noted that an MZI having FSR of 22 GHz is used as the MZI6 and the temperature compensation groove 64a of approximately 240 μm in length is provided in the arm waveguide 63a of the MZI6. It should be noted that the temperature compensation groove is not provided in the arm waveguide 63b.

FIG. 3 is a diagram showing the temperature dependence of the transmission center wavelength of the wavelength multiplexer/demultiplexer according to the embodiment. For comparison, in FIG. 3, the temperature dependence of the center wavelength of a wavelength multiplexer/demultiplexer which has not been athermalized is also shown. From FIG. 3, it can be seen that the temperature dependence of the center wavelength of the wavelength multiplexer/demultiplexer can be compensated by the configuration of the embodiment.

FIG. 4 is a diagram showing a temporal change of the transmission center wavelength variation in the reliability test of the wavelength multiplexer/demultiplexer according to the embodiment. For comparison, in FIG. 4, there is also shown a temporal change of the center wavelength variation when a silicone resin with a hardness of 25 as the temperature compensation material is filled into the temperature compensation groove 64a of the MZI6 and a silicone oil with a viscosity of 3000 mm²/s as the refractive-index matching material is filled into the space 9 (i.e., a temporal change of the center wavelength variation of a related art example). From FIG. 4, it can be seen that the increase in the variation of the center wavelength occurs as time elapses in the related art example, while in the wavelength multiplexer/demultiplexer of the embodiment, even after the elapse of time, the center wavelength is kept substantially constant and a higher reliability can be obtained. In this manner, according to the embodiment, the temporal stability of the transmission center wavelength of the wavelength multiplexer/demultiplexer 1 can be improved, and the wavelength multiplexer/demultiplexer 1 can be well operated even after the lapse of a long time.

Next, in cases where the above-described silicone oil is used as the compensation material, a method of manufacturing the wavelength multiplexer/demultiplexer will be explained.

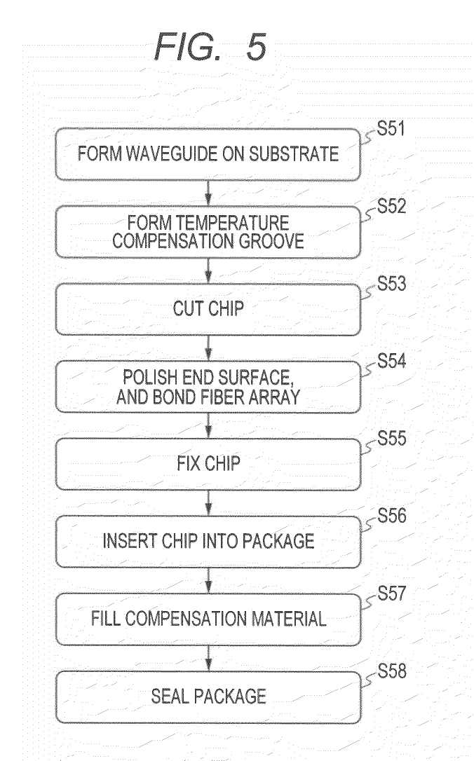

FIG. 5 is a view showing the steps of manufacturing the wavelength multiplexer/demultiplexer according to the embodiment.

In FIG. 5, in Step S51, the AWG5 and MZI6 are formed on a substrate, which has not been separated yet into the first substrate section 3a and the second substrate section 3b. It should be noted that the AWG5 and MZI6 may be formed by using a method commonly used. Next, in Step S52, the temperature compensation grooves 64a and 64b are formed by dry etching or the like in each of the arm waveguides 63a and 63b of the MZI6 fabricated in Step S51. Next, in Step S53, the slab waveguide 51 is separated by using a dicing saw or the like at a plane crossing the path of light passing through the slab waveguide 51 and is cut so as to form the separated slab waveguides 51a and 51b, and the substrate having the AWG5 and MZI6 formed therein is separated into the first substrate section 3a and the second substrate section 3b.

Next, in Step S54, the end surface of the input optical fiber 7, the end surface of the output optical fiber 8, and the end surfaces of the wavelength multiplexer/demultiplexer 1 to which these optical fibers are coupled are polished, and the input optical fiber 7 and the output optical fiber 8 are bonded to the wavelength multiplexer/demultiplexer 1. Next, in Step S55, the first substrate section 3a and the second substrate section 3b are fixed to each other via the compensation member 4. At this time, the separated slab waveguide 51a and the separated slab waveguide 51b are arranged so as to face each other, and the separated first substrate section 3a and the second substrate section 3b are connected to each other via the compensation member 4. It should be noted that the compensation member 4 may be bonded to the first substrate section 3a and the second substrate section 3b with an adhesive or the like. Next, in Step S56, the wavelength multiplexer/demultiplexer 1 having the first substrate section 3a, the second substrate section 3b, and the compensation member 4 is arranged in the package 2 via an elastic member (not shown).

In this manner, through Steps S51 to S56, the wavelength multiplexer/demultiplexer 1 having the temperature compensation grooves 64a and 64b and the space 9 not filled with the compensation material 10 is prepared.

Next, in Step S57, a silicone oil as the compensation material is supplied to the wavelength multiplexer/demultiplexer 1, which is arranged in the package in Step S56, and the same silicone oil is filled into the space 9 and the temperature compensation grooves 64a and 64b. Accordingly, inside the package 2, the wavelength multiplexer/demultiplexer 1 is immersed with the silicone oil.

Next, in Step S58, a lid is put on the package 2, and the lid and the package 2 are jointed together by seam welding, laser welding, or the like to thereby seal the package. Thus, the wavelength multiplexer/demultiplexer 1 having the space 9 and the temperature compensation grooves 64a and 64b filled with the silicone oil is hermetically sealed.

In the embodiment, the material filled into the space 9 and the material filled into the temperature compensation grooves 64a and 64b are the identical compensation material, and the substantially entire chip (wavelength multiplexer/demultiplexer 1) is immersed into the compensation material. That is, the temperature compensation grooves 64a and 64b formed in the arm waveguides 63a and 63b of the MZI6, and the space 9 as the cut part of the chip are simultaneously filled with the material (compensation material) serving as the refractive-index matching material and also as the temperature compensation material. Accordingly, the assembly cost can be reduced and the chip can be also protected.

Traditionally, a step corresponding to Step S57 of FIG. 5 is the step of filling a refractive-index matching material into the separated part of the slab waveguide, and further, between a step corresponding to Step S54 and a step corresponding to Step S55, two steps: a step of filling a resin as the temperature compensation material into the temperature compensation groove formed in the arm waveguide of the MZI; and a step of curing the resin, have had to be additionally performed. However, in the embodiment, these two steps can be eliminated.

Moreover, the entire wavelength multiplexer/demultiplexer is hermetically sealed, and thus, the same high-reliability as in the ordinary athermal AWG can be obtained.

Furthermore, the compensation material is a liquid such as a silicone oil, and thus, the compensation material can be easily filled into the sections (the temperature compensation grooves 64a and 64b, and the space 9) in which the compensation material is required, and also an excellent temperature compensation characteristics can be obtained without preventing the position change of the AWG section caused by the compensation member 4.

Meanwhile, in the above-described embodiment, a liquid such as a silicone oil has been explained as the compensation material according to the embodiment. However, through the use of a gel (e.g., a silicone gel deformable to such an extent that the temperature compensation operation is not prevented) or a resin (e.g., a silicone resin deformable to such an extent that the temperature compensation operation is not prevented) having the nature of the compensation material described above, the compensation material can be arranged only in the temperature compensation grooves 64a and 64b and space 9 in which the compensation material is required. Moreover, by setting the compensation material as a gel, the compensation material can be easily filled and at the same time the hardness of the compensation material of such an extent that does not prevent the position change of the AWG section caused by the compensation member can be obtained and the handling property can be more improved than that in the case of a liquid.

Furthermore, by setting the compensation material as a silicone resin, adequate compensation material characteristics in which both the refractive index matching and the temperature dependence of the refractive index are combined can be obtained.

It should be noted that, when a gel or a resin is used as the compensation material, a step of curing the compensation material filled into the temperature compensation grooves 64a and 64b and the space 9 may be performed between Step S57 and Step S58.

### Second Embodiment

In the related art, it has been proposed that a solid-state resin material is used as the temperature compensation material for athermalization of the MZI and a material in the form of oil or gel is used as the refractive-index matching material between the separated slab waveguides. As the compensation material serving as the temperature compensation material and also as the refractive-index matching material, which is used in the wavelength multiplexer/demultiplexer comprising the MZI and AWG (also referred to as the “MZI-AWG”) according to the first embodiment, a material in the form of oil or gel having fluidity or plasticity or a material in the form of resin will be used so as not to prevent the relative position change between the cut chips corresponding to the change in temperature.

On the other hand, in order to obtain a flat transmission band characteristics in a desired wavelength band region in the MZI-AWG, the transmission wavelength characteristics of the MZI section and the transmission wavelength characteristics of the AWG section need to be synchronized with each other in the desired wavelength band region. However, since each of the MZI section and the AWG section has a fabrication error and the transmission wavelength characteristics of the both are usually not synchronized with each other at the time of the fabrication, the position adjustment of the cut parts of the AWG and the phase trimming of the arm waveguide part of the MZI by UV light or the like are performed to obtain the desired characteristics.

In the related art, since the temperature compensation material has been in a solid state, the phase trimming of the MZI by UV light or the like is performed after filling and curing the temperature compensation material, to thereby adjust the MZI to the desired characteristics, and then the desired characteristics are obtained by adjusting and fixing the position of the cut part of the AWG.

In the embodiment, a method of matching the transmission wavelength characteristics of the MZI to the transmission wavelength characteristics of the AWG in the wavelength multiplexer/demultiplexer (MZI-AWG) explained in the first embodiment, will be explained.

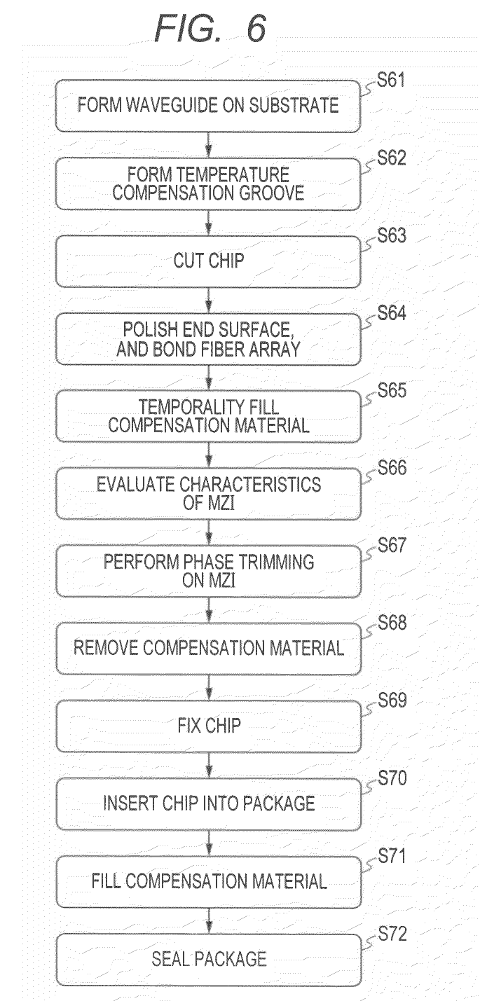

FIG. 6 is a view showing a method of fabricating the wavelength multiplexer/demultiplexer according to the embodiment. In the embodiment, a case where a silicone oil is used as the compensation material will be explained. It should be noted that, in FIG. 6, since Steps S61 to S64 and Steps S69 to S72 are the same as Steps S51 to S58 of FIG. 5, the explanation thereof is omitted.

In FIG. 6, after performing Step S61 to Step S64, in Step S65 a silicone oil identical to the one used in Step S71 is filled into the temperature compensation grooves 64a and 64b. Since this is performed for the purpose of phase trimming of the MZI6, this can be said to be the temporary filling of the compensation material. Next, in Step S66, in a state where the compensation material is temporarily filled, the light of a predetermined wavelength band is input from the input optical fiber 7 to the wavelength multiplexer/demultiplexer 1 having the current configuration, and the light output from the output optical fiber 8 is detected to thereby determine whether or not the transmission wavelength characteristics of the MZI6 and the transmission wavelength characteristics of the AWG5 are synchronized with each other and perform the characteristic evaluation of the MZI6. Next, in Step S67, based on the result of the characteristic evaluation in Step S66, the phase trimming by UV light irradiation or the like onto the arm waveguide of the MZI is performed so that the transmission wavelength characteristics of the MZI6 agree with the transmission wavelength characteristics of the AWG5. Thus, in the desired wavelength band region, the transmission wavelength characteristics of the MZI6 can be matched with the transmission wavelength characteristics of the AWG5. Next, in Step S68, the silicone oil temporarily filled into the temperature compensation grooves 64a and 64b is removed.

The wavelength multiplexer/demultiplexer of the embodiment is substantially the same as the wavelength multiplexer/demultiplexer of the first embodiment, but differs from that of the first embodiment in that in the steps in the middle of the fabrication, the compensation material is temporarily filled into the temperature compensation grooves 64a and 64b formed in the arm waveguide of MZI6 and the characteristics of the MZI6 are evaluated, and the phase trimming of the MZI6 is performed prior to the main filling (filling in Step S71) of the compensation material.

In this manner, the adjustment of characteristics of the MZI6 is performed in the state where the compensation material is temporarily filled, and thus the transmission wavelength characteristics of the MZI section and the transmission wavelength characteristics of the AWG section can be synchronized with each other and the desired characteristics can be easily obtained.

According to one of the present invention, in a wavelength multiplexer/demultiplexer comprising a Mach-Zehnder interferometer and an arrayed waveguide grating, the degradation and peeling-off of a temperature compensation material provided in the Mach-Zehnder interferometer can be reduced with a simple configuration.

What is claimed is:

1. A wavelength multiplexer/demultiplexer, comprising:
a Mach-Zehnder interferometer having two arm waveguides coupled to one or more first waveguides; and
an arrayed waveguide diffraction grating including a first slab waveguide coupled to the Mach-Zehnder interferometer, an arrayed waveguide having a plurality of waveguides of different optical path lengths coupled to the first slab waveguide, a second slab waveguide coupled to the arrayed waveguide, and a plurality of second waveguides arranged in parallel and coupled to the second slab waveguide, wherein
the first slab waveguide is separated in a plane crossing a path of light passing through the first slab waveguide, the wavelength multiplexer/demultiplexer further comprising:
a first member having one of the separated first slab waveguides and the Mach-Zehnder interferometer provided therein;
a second member having the other one of the separated first slab waveguides and the arrayed waveguide provided therein; and
a temperature compensation mechanism which changes a relative position between one of the separated first slab waveguides and the other one of the separated first slab waveguides by moving at least one of the first member and the second member in accordance with the change in temperature so that a temperature dependence of a transmission center wavelength of the arrayed waveguide diffraction grating decreases, wherein
a groove provided so as to cross the arm waveguide is formed in at least one of the two arm waveguides of the Mach-Zehnder interferometer, and
into the groove, and between one of and the other one of the separated first slab waveguides, an identical compensation material having a refractive index matching that of a waveguide core of the arrayed waveguide diffraction grating and the Mach-Zehnder interferometer, a temperature dependence coefficient different from a temperature dependence coefficient of the waveguide core, and plasticity or fluidity, is filled.

2. The wavelength multiplexer/demultiplexer according to claim 1, wherein the compensation material is a liquid.

3. The wavelength multiplexer/demultiplexer according to claim 1, wherein the compensation material is a gel.

4. The wavelength multiplexer/demultiplexer according to claim 1, wherein the compensation material is a silicone resin.

5. A method for manufacturing the wavelength multiplexer/demultiplexer according to claim 1, the method comprising the steps of:
preparing a configuration having the arrayed waveguide diffraction grating, the Mach-Zehnder interferometer, and the temperature compensation mechanism formed therein; and
filling the identical compensation material into the groove, and between one of and the other one of the separated first slab waveguides.

6. The method according to claim 5, further comprising the step of:
filling the identical compensation material into the groove before the step of filling the identical compensation material;
performing phase trimming on the Mach-Zehnder interferometer so that a transmission wavelength characteristics of the arrayed waveguide diffraction grating and a transmission wavelength characteristics of the Mach-Zehnder interferometer synchronize with each other; and
removing the compensation material which is filled into the groove after the phase trimming is completed.
